(19) United States
(12) Patent Application Publication
(10) Pub. No.: US 2025/0312908 A1
(43) Pub. Date: Oct. 9, 2025

(54) MOBILE WORKBENCH WITH STOWABLE AND DEPLOYABLE SUPPORT STRUCTURE

(71) Applicant: Pacifica Innovations, LLC, Carlsbad, CA (US)

(72) Inventors: Justin Malone, Carlsbad, CA (US); Robert Colucci, Rancho Santa Fe, CA (US)

(21) Appl. No.: 18/628,577

(22) Filed: Apr. 5, 2024

(51) Int. Cl. B25H 1/04

(52) U.S. Cl. CPC B25H 1/04

(57) ABSTRACT

A mobile workbench or mobile cart may include a platform with a work surface; a lower support structure positioned beneath the platform and spaced apart from the platform along a vertical axis; a plurality of support elements extending between the lower support structure and the platform, the support elements positioned to maintain spacing between the lower support structure and the platform; and a plurality of leg elements. In some embodiments, each leg element may be pivotably attached to the platform at a first end, and each leg element may have a foot element at a second end for contacting a ground surface. Each leg element may be movable between a deployed configuration to support the workbench, and a stowed configuration. In some embodiments, at least two of the leg elements may also be translatably attached to the platform at their first ends.

### BACKGROUND

Workers at remote job sites typically carry their tools in small bags with limited capacity or in bulky tool chests that require adaptation or permanent connection to a vehicle. Workers at remote job sites also often need a workspace but these sites do not always have a clean or level surface on which to work.

### SUMMARY

Representative embodiments of the present technology include a mobile workbench or mobile cart having a platform with a work surface; a lower support structure positioned beneath the platform and spaced apart from the platform along a vertical axis; a plurality of support elements extending between the lower support structure and the platform, the support elements positioned to maintain spacing between the lower support structure and the platform; and a plurality of leg elements. In some embodiments, each leg element may be pivotably attached to the platform at a first end, and each leg element may have a foot element at a second end for contacting a ground surface. Each leg element may be movable between a deployed configuration to support the workbench, and a stowed configuration. In some embodiments, at least two of the leg elements may also be translatably attached to the platform at their first ends. Optional locking mechanisms may restrict movement of the leg elements when the leg elements are deployed.

Other features and advantages will appear hereinafter. The features described herein can be used separately or together, or in various combinations of one or more of them.

### BRIEF DESCRIPTION OF THE DRAWINGS

In the drawings, wherein the same reference number indicates the same element throughout the views:

FIG. 1 illustrates a perspective view of a mobile cart configured in accordance with embodiments of the present technology;

FIGS. 2-7, respectively, illustrate perspective views of a sequence of deploying (or in the reverse, a sequence of stowing) the mobile cart shown in FIG. 1; and

FIG. 8 illustrates a perspective exploded view of the mobile cart shown in FIGS. 1-7.

### DETAILED DESCRIPTION

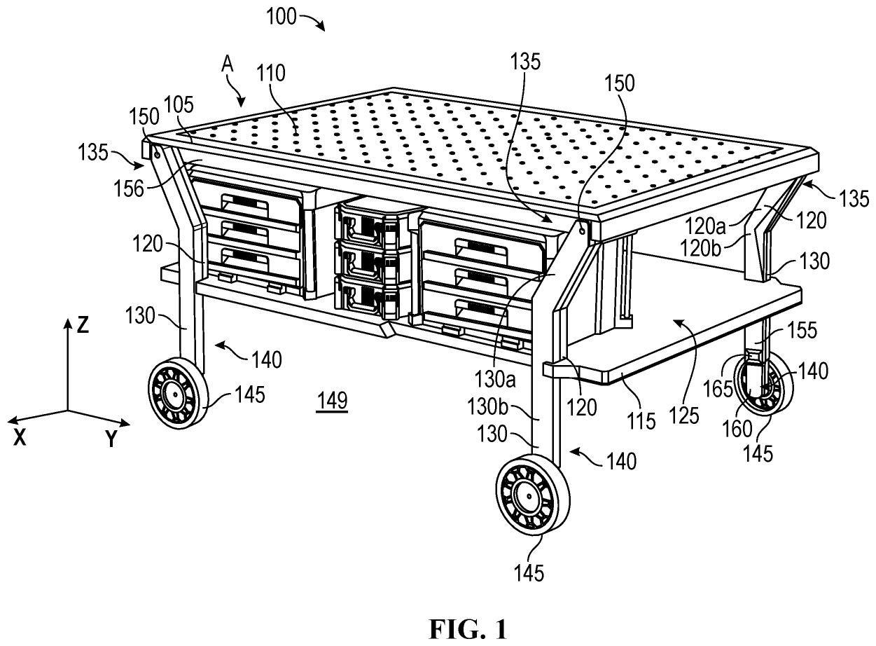

The present technology is directed to mobile carts, such as mobile workbenches, with stowable and deployable support structures, and associated systems and methods. Various embodiments of the technology will now be described. The following description provides specific details for a thorough understanding and enabling description of these embodiments. One skilled in the art will understand, however, that the invention may be practiced without many of these details. Additionally, some well-known structures or functions may not be shown or described in detail to avoid unnecessarily obscuring the relevant description of the various embodiments. Accordingly, embodiments of the present technology may include additional elements or exclude some of the elements described below with reference to FIGS. 1-8, which illustrate examples of the technology.

The terminology used in this description is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components. Numerical adjectives including “first” and “second,” as used in the present disclosure, do not convey hierarchy or specific features or functions. Rather, such numerical adjectives are intended to aid the reader in distinguishing between elements that may have similar nomenclature but that may differ in position, orientation, or structure. Accordingly, such numerical adjectives may be used differently in the claims.

Specific details of several embodiments of the present technology are described herein with reference to mobile carts or mobile workbenches. Embodiments of the present technology can be implemented in other mobile carts for storage, transportation, or other uses.

FIG. 1 illustrates a perspective view of a mobile cart 100 configured in accordance with embodiments of the present technology. In some embodiments, the mobile cart 100 may include an upper support structure such as a platform 105 with a work surface 110 capable of forming a workspace for a user, such that the mobile cart 100 may be a mobile workbench. In some embodiments, the platform 105 may be formed as a frame structure that supports the work surface 110. The mobile cart 100 may further include a lower support structure 115 positioned beneath the platform 105 and spaced apart from the platform 105 along a vertical axis Z. In some embodiments, the lower support structure 115 may be a frame structure, or in other embodiments it may have any other suitable plane-like structure. A plurality of support elements 120 (e.g., four support elements 120, such as one at each corner of the mobile cart 100) may extend between the platform 105 and the lower support structure 115, to maintain spacing between the lower support structure 115 and the platform 105. The spacing may form an area 125 for storage or other uses.

In some embodiments, the mobile cart 100 further includes a plurality of leg elements 130 (e.g., four leg elements 130, such as one at each corner of the mobile cart 100). Each leg element 130 may include a first end 135 and a second end 140 positioned opposite the first end 135 along a length of the leg element 130. One or more (such as two or more, or all) of the first ends 135 may be pivotably, slidably, or both pivotably and slidably attached to the platform 105, as described in further detail below. Each second end 140 may carry a foot element 145 configured to contact a ground surface 149.

In some embodiments, one or more of the foot elements 145 can be in the form of a rolling wheel that can rotate relative to the leg element 130. In some embodiments, one or more of the first ends 135 may be pivotably attached to the platform 105 via a rotatable joint 150, and, optionally, the rotatable joint 150 may be slidable relative to the platform 105 along a track element 156, to facilitate the pivoting or sliding relationship between the first end 135 and the platform 105. In some embodiments, only two of the first ends 135 (e.g., the first ends 135 on a first side A of the platform 105) may be pivotable and slidable relative to the platform 105, while two of the other leg elements 130 may only pivot relative to the platform 105.

In some embodiments, one or more (such as all) of the leg elements 130 may be height-adjustable. For example, in some embodiments, one or more (such as all) of the leg elements 130 may include at least a first leg element portion 155 and second leg element portion 160. The first leg element portion 155 may be movable relative to the second leg element portion 160 to increase or decrease the distance between the first end 135 and the second end 140, to raise and lower the height of the platform 105. In some embodiments, the first leg element portion 155 is movable relative to the second leg element portion 160 via a telescoping relationship (e.g., the second leg element portion 160 may carry the foot element 145, and it may slide into or out of the first leg element portion 155). In some embodiments, one or more of the leg elements 130 may include a motorized, hydraulic, or pneumatic actuator 165 (shown schematically) for raising and lowering the platform 105, for example, by operating the telescoping relationship between the first leg element portion 155 and the second leg element portion 160.

In some embodiments, the leg elements 130 may be shaped to correspond to the shape of the support elements 120. For example, in some embodiments, each support element 120 may include two segments 120a, 120b, which may be oriented at oblique angles relative to each other. Similarly, in some embodiments, each leg element 130 may include two segments 130a, 130b that are oriented at oblique angles relative to each other, such that in a deployed configuration of the mobile cart 100, as shown in FIG. 1, the leg elements 130 may be generally parallel with, or aligned along, the support elements 120.

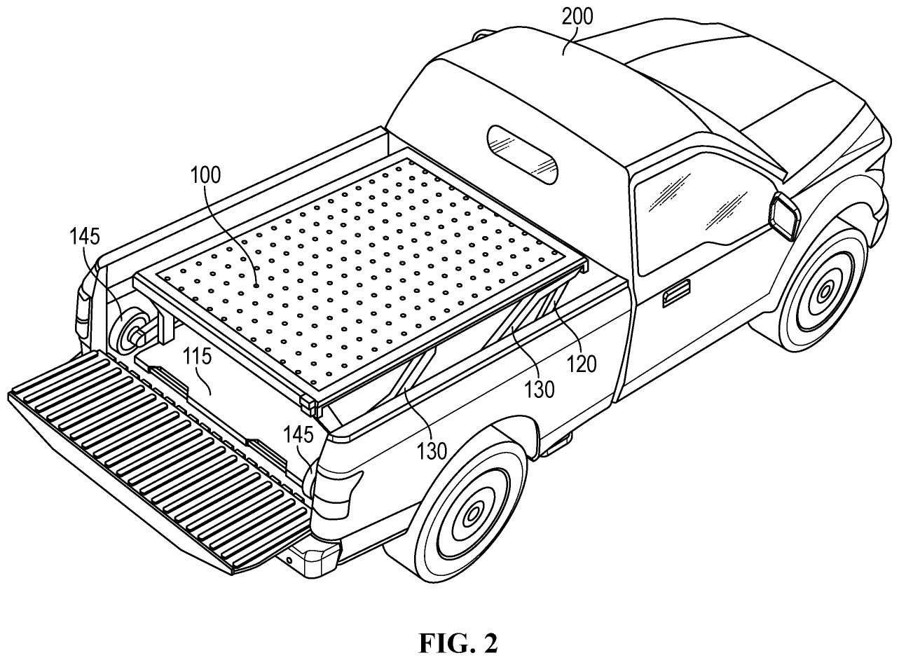

FIG. 1 shows the mobile cart 100 in a deployed configuration, ready for use. FIGS. 2-7 illustrate a sequence of deploying (or in the reverse, a sequence of stowing) the mobile cart 100. For example, FIG. 2 illustrates a rear perspective view of a vehicle 200 carrying the mobile cart 100 in a stowed configuration, according to embodiments of the present technology. An advantage of the mobile cart 100 is that it may be stowed in, transported in, and deployed from any suitable vehicle 200, such as a pickup truck. In the stowed configuration, the leg elements 130 are pivoted, translated, or both pivoted and translated to bring the foot elements 145 near the lower support structure 115 to effectively collapse the mobile cart 100 along the vertical axis so that it has a low profile in the vehicle 200.

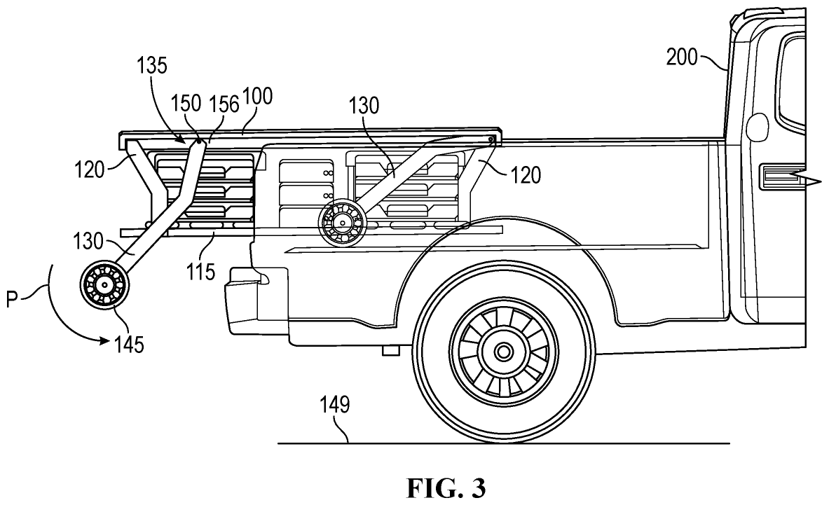

FIG. 3 illustrates a schematic side view of the vehicle 200 and the mobile cart 100, with the mobile cart 100 in a partially deployed configuration. In use, an operator can move the mobile cart 100 partially out of the vehicle 200 to enable two of the leg elements 130 to be deployed. The two leg elements 130 that are outside of the vehicle 200 can be rotated about the first ends 135 via the rotatable joint 150 and, optionally, the first ends 135 may be translated along the track element 156 to cause the leg elements 130 to move along the deployment pathway P to bring the foot elements 145 toward the ground.

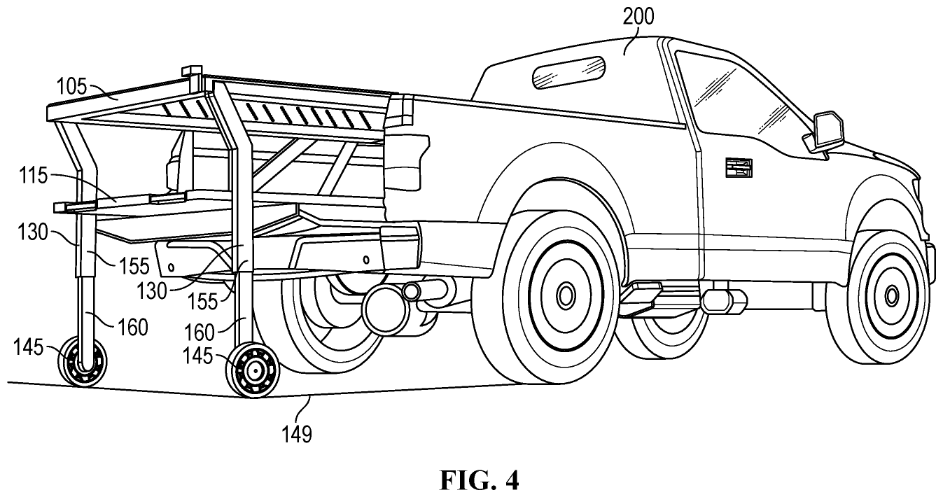

FIG. 4 illustrates a rear perspective view of the vehicle 200 and the mobile cart 100, with the mobile cart 100 in a further partially deployed configuration (or a partially stowed configuration). In FIG. 4, the leg elements 130 have been fully rotated downward and, optionally, their telescoping portions 155, 160 extended to allow the foot elements 145 to rest on the ground surface 149 to begin supporting some of the weight of the mobile cart 100. Accordingly, in some embodiments, one or more leg elements 130 may be movable between a deployed configuration in which the leg element 130 is oriented to position the foot element 145 at a location that is a first distance below the lower support structure 115, and a stowed configuration in which the leg element 130 is oriented to position the foot element 145 at a location that is a second distance below the lower support structure 115, wherein the second distance is less than the first distance.

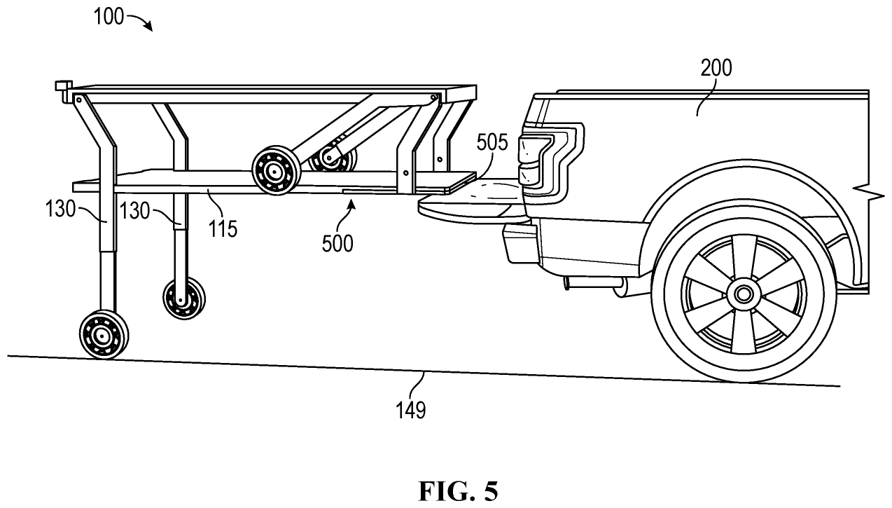

FIG. 5 illustrates a side perspective view of the vehicle 200 and the mobile cart 100, with the mobile cart 100 in a further partially deployed configuration (or a partially stowed configuration). With two of the leg elements 130 deployed such that the foot elements 145 are supported on the ground surface 149, an operator may continue pulling the mobile cart 100 from the vehicle 200. An end of the lower support structure 115 may rest on, and be supported by, the vehicle 200 as the mobile cart 100 is pulled from the vehicle 200. In some embodiments, a lower surface 500 of the lower support structure 115 may include a low-friction material 505 or other low-friction surface to facilitate sliding the mobile cart 100 out of the vehicle 200. For example, the low-friction material 505 may be in the form of a pad element attached to the underside or lower surface 500 of the lower support structure 115. The low-friction material or low-friction surface may have a lower coefficient of friction than any remainder of the lower surface 500 of the lower support structure 115.

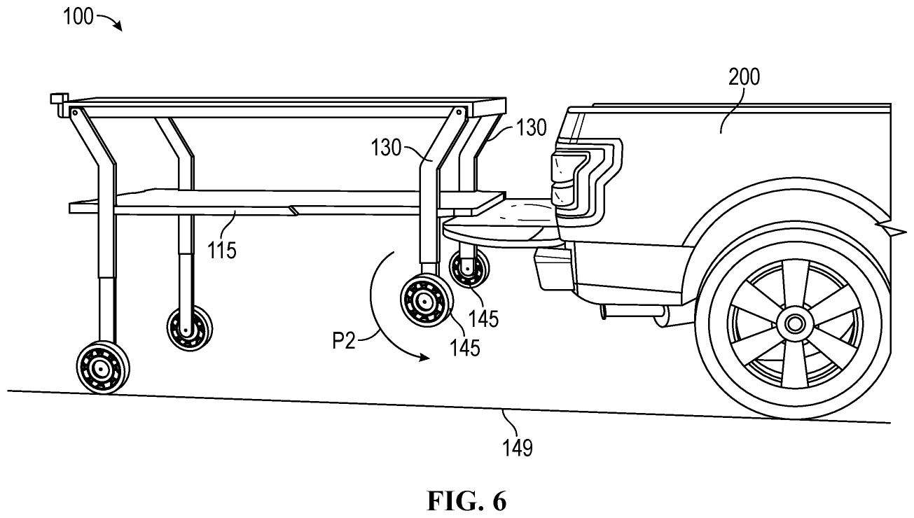

FIG. 6 illustrates a side perspective view of the vehicle 200 and the mobile cart 100, with the mobile cart 100 in a further partially deployed or partially stowed configuration. In FIG. 6, the two other leg elements 130 have been rotated along pathway P2 about their first ends 135 to begin their deployment. In some embodiments, the foot elements 145 may not yet reach the ground surface 149.

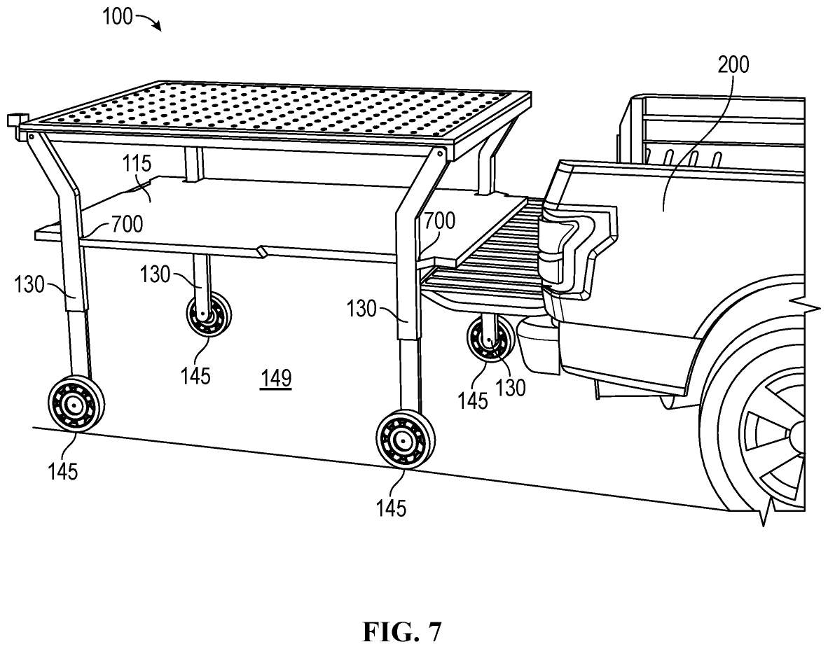

FIG. 7 illustrates a perspective view of the vehicle 200 and the mobile cart 100 in a mostly deployed configuration with the leg elements 130 fully extended. All the foot elements 145 are supporting the mobile cart 100 on the ground surface 149, and the mobile cart 100 may be moved (e.g., rolled) away from the vehicle 200.

In some embodiments, height adjustment to facilitate different vehicle 200 heights, or to otherwise level the mobile cart 100, may be performed via the height adjustment of each of the leg elements 130 (e.g., the telescoping components described above). In some embodiments, the lower support structure 115 may include one or more protruding edge elements 700 positioned to resist movement of one or more corresponding leg elements 130 beyond the deployed configuration.

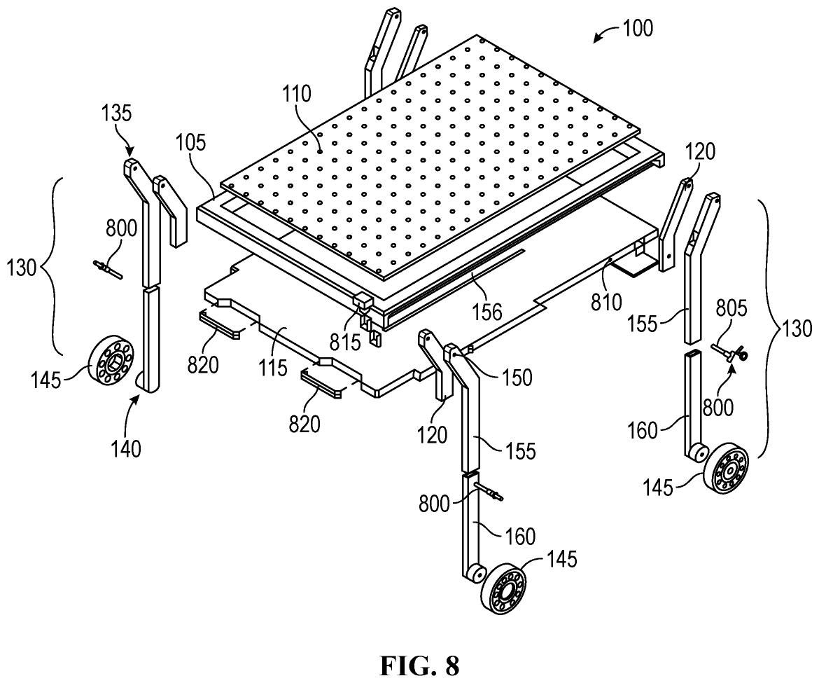

FIG. 8 illustrates a perspective exploded view of the mobile cart 100, according to embodiments of the present technology. In some embodiments, the mobile cart 100 may include one or more locking mechanisms 800, such as one locking mechanism 800 for each leg element 130. The locking mechanisms 800 are positionable and operable to selectively restrict motion of a corresponding leg element 130 relative to the lower support structure 115 when the corresponding leg element 130 is in the deployed configuration. For example, a representative locking mechanism may include a pin 805 positionable to pass through a leg element 130 and into an opening 810 in the lower support structure 115. The shear strength of the pin 805 resists rotation/movement of the leg element 130, thereby resisting motion of the leg element 130 away from the deployed configuration.

In some embodiments, the mobile cart 100 may include a receptacle 815 positioned and configured to receive a power source, such as a battery or a wired connection, to supply power to the mobile cart 100, such as for accessories usable on the work surface 110 or to power actuators associated with raising and lowering the platform 105. In some embodiments, one or more pull handles 820 may be attached to the mobile cart 10, such as on the lower support structure 115, to assist with pushing or pulling the mobile cart 100 in or out of a vehicle.

In use, a method according to embodiments of the present technology may include a method of deploying a mobile cart 100 from a vehicle 200. The method may include sliding the mobile cart 100 at least partially out of an opening in the vehicle 200, then deploying two first leg elements 130. Deploying the two first leg elements 130 may include (a) pivoting and sliding a second end 140 of each of the two first leg elements 130 relative to the upper support structure or platform 105 of the mobile cart 100, and (b) locking each of the two first leg elements 130 in a deployed configuration using a locking mechanism 800, such as a pin 805.

The method may further include sliding the mobile cart 100 farther out of the opening in the vehicle 200, then deploying two second leg elements 130. Deploying the two second leg elements 130 may include (a) pivoting a second end 140 of each of the two second leg elements 130 relative to the upper support structure or platform 105, and (b) locking each of the two second leg elements 130 in a deployed configuration using a locking mechanism 800, such as a pin 805. Using the locking mechanism may include engaging each locking mechanism with the lower support structure 115 beneath the upper support structure or platform 105. Deploying the leg elements 130 may include telescopically extending the leg elements 130. Stowing the mobile cart 100 may be performed as a reverse deployment procedure.

The present technology provides a stowable and deployable mobile cart that may include storage for tools or supplies and an adjustable-height work surface for convenient customization and use at a remote job site. Mobile carts according to embodiments of the present technology may fit between wheel wells of pickup trucks or vans, and they do not need to be permanently affixed to a vehicle like conventional tool storage devices. Embodiments of the present technology may include kits of parts comprising any quantity or combination of any of the components disclosed herein.

From the foregoing, it will be appreciated that specific embodiments of the presently disclosed technology have been described herein for purposes of illustration, but that various modifications may be made without deviating from the scope of the technology.

Certain aspects of the technology described in the context of particular embodiments may be combined or eliminated in other embodiments. Further, while advantages associated with certain embodiments of the presently disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A mobile workbench, comprising:
a platform including a planar work surface;
a lower support structure positioned beneath the platform and spaced apart from the platform along a vertical axis;
a plurality of support elements extending between the lower support structure and the platform, and positioned to maintain spacing between the lower support structure and the platform, wherein each support element is spaced apart from each other support element, and wherein the planar work surface extends between the support elements;
a plurality of leg elements, wherein each leg element includes a first end and a second end, each first end is pivotably attached to the platform, each second end carries a foot element configured to contact a ground surface, and each leg element is movable between a deployed configuration in which the leg element is oriented to position the foot element at a location that is a first distance below the lower support structure, and a stowed configuration in which the leg element is oriented to position the foot element at a location that is a second distance from the lower support structure, wherein the second distance is less than the first distance; and
a plurality of locking mechanisms, wherein each locking mechanism is operable to selectively restrict motion of a corresponding leg element of the plurality of leg elements relative to the lower support structure when the corresponding leg element is in the deployed configuration.

2. The mobile workbench of claim 1, wherein the plurality of leg elements comprises four leg elements, wherein two of the four leg elements are both pivotably and slidably attached to the platform.

3. The mobile workbench of claim 2, wherein each first end of the two pivotable and slidable leg elements is pivotably and slidably attached to the platform via a rotatable joint that is slidable along a track element supported on the platform.

4. The mobile workbench of claim 1, wherein at least one of the foot elements comprises a wheel positioned to rotate relative to the corresponding leg element.

5. The mobile workbench of claim 1, wherein at least one of the leg elements of the plurality of leg elements comprises a first leg portion and a second leg portion, wherein the first leg portion is movable relative to the second leg portion to increase or decrease a distance between the first end and the second end of the leg element.

6. The mobile workbench of claim 5, wherein the first leg portion is movable relative to the second leg portion via a telescoping relationship between the first leg portion and the second leg portion.

7. The mobile workbench of claim 5, wherein the first leg portion is movable relative to the second leg portion via a motorized connection between the first leg portion and the second leg portion.

8. The mobile workbench of claim 7, further comprising a receptacle positioned and configured to receive a power source to supply power to an actuator of the motorized connection.

9. The mobile workbench of claim 1, wherein the platform comprises a frame structure supporting the work surface, and wherein each leg element is pivotably attached to the frame structure.

10. The mobile workbench of claim 1, wherein at least one of the locking mechanisms comprises a pin element positionable to pass through the corresponding leg element and into the lower support structure.

11. The mobile workbench of claim 1, further comprising one or more pull handles attached to the platform or the lower support structure.

12. The mobile workbench of claim 1, further comprising a pad element attached to an underside surface of the lower support structure, wherein the pad element comprises a surface having a lower coefficient of friction than the underside surface of the lower support structure.

13. A mobile storage cart for transporting in a vehicle and deploying from the vehicle, the cart comprising:
an upper support structure;
a lower support structure positioned beneath the upper support structure and spaced apart from the upper support structure;
a plurality of support elements extending between the upper support structure and the lower support structure and positioned to maintain spacing between the upper support structure and the lower support structure, wherein each support element is spaced apart from each other support element; and
a plurality of leg elements extending from the upper support structure, wherein each leg element includes a first end and a second end, each first end is pivotably attached to the upper support structure, and each leg element is movable between a deployed configuration and a stowed configuration, wherein in the deployed configuration, the leg elements extend beyond the lower support structure;
wherein, for each leg element of the plurality of leg elements, when the leg element is in the deployed configuration, the second end is positioned below the lower support structure by a first distance and the second end is positionable to support the mobile storage cart on a surface, and when the leg element is in the stowed configuration, the second end is positioned closer to the lower support structure than the first distance.

14. The mobile storage cart of claim 13, further comprising a plurality of locking mechanisms operable to selectively restrict motion of the leg elements away from the deployed configuration.

15. The mobile storage cart of claim 13, wherein each second end carries a foot element or a wheel.

16. The mobile storage cart of claim 13, wherein at least two of the first ends are slidable relative to the upper support structure.

17. The mobile storage cart of claim 13, wherein each leg element comprises a telescoping mechanism to extend or retract a length of the leg element.

18. The mobile storage cart of claim 13, wherein each leg element comprises a first leg element segment and a second leg element segment, wherein the first leg element segment is oriented at an oblique angle relative to the second leg element segment, and wherein when the leg element is in the deployed configuration, the first leg element segment is parallel to a first support element segment of an adjacent support element, and the second leg element segment is parallel to a second support element segment of the adjacent support element.

19. The mobile storage cart of claim 13, wherein the lower support structure comprises an edge element positioned to resist movement of at least one of the leg elements beyond the deployed configuration after the at least one of the leg elements is deployed.

20. A method of deploying a mobile cart from a vehicle,
the method comprising:
sliding the mobile cart at least partially out of an opening in the vehicle; then deploying two first leg elements, wherein deploying the two first leg elements comprises (a) pivoting an end of each of the two first leg elements via a slidable joint attached to an upper support structure of the mobile cart, (b) sliding the end via the slidable joint, and (c) locking each of the two first leg elements in a deployed configuration using a locking mechanism; then
sliding the mobile cart farther out of the opening in the vehicle; then
deploying two second leg elements, wherein deploying the two second leg elements comprises (a) pivoting an end of each of the two second leg elements relative to the upper support structure, and (b) locking each of the two second leg elements in a deployed configuration using a locking mechanism; wherein
using each locking mechanism comprises engaging each locking mechanism with a lower support structure beneath the upper support structure.
